(19) United States
(12) Patent Application Publication
(10) Pub. No.: US 2025/0150992 A1
(43) Pub. Date: May 8, 2025

(54) SYNCHRONIZATION SIGNAL BLOCK CONFIGURATIONS FOR SIDELINK COMMUNICATIONS

(71) Applicant: QUALCOMM Incorporated, San Diego, CA (US)

(72) Inventors: Yiqing CAO, Beijing (CN); Yuan KAI, Shanghai (CN); Juan MONTOJO, San Diego, CA (US); Peter GAAL, San Diego, CA (US); Shuping CHEN, Beijing (CN); Bin HAN, Beijing (CN); Ting WANG, Beijing (CN); Lu GAO, Beijing (CN); Zhimin DU, Beijing (CN); Yang LIU, Beijing (CN); Yan LI, Beijing (CN); Jiangsheng WANG, Shanghai (CN); Yue YIN, Beijing (CN); Qiwen DENG, Beijing (CN); Zhuo CHEN, Shanghai (CN); Sony AKKARAKARAN, Poway, CA (US)

(21) Appl. No.: 18/694,062

(22) PCT Filed: Nov. 19, 2021
(86) PCT No.: PCT/CN2021/131653

§ 371 Date: Mar. 21, 2024

(51) Int. Cl. H04W 56/00; H04W 74/0808; H04W 92/18

(52) U.S. Cl. CPC H04W 56/00; H04W 74/0808; H04W 92/18

(57) ABSTRACT

Wireless communications systems and methods related to communicating control information are provided. A method of wireless communication performed by a first sidelink user equipment (UE) may include transmitting, to a second sidelink UE, a first sidelink synchronization block (S-SSB) in a scheduled S-SSB slot, performing a first listen-before-talk (LBT) procedure in an unlicensed frequency band, and transmitting, to the second sidelink UE, a second S-SSB in a slot before a next scheduled S-SSB slot based on the first LBT procedure being unsuccessful.

### TECHNICAL FIELD

This application relates to wireless communication systems, and more particularly, to configuring sidelink-synchronization signal block (S-SSB) transmissions in a shared radio frequency band.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first sidelink user equipment (UE) may include transmitting, to a second sidelink UE, a first sidelink synchronization block (S-SSB) in a scheduled S-SSB slot; performing a first listen-before-talk (LBT) procedure in an unlicensed frequency band; and transmitting, to the second sidelink UE, a second S-SSB in a slot before a next scheduled S-SSB slot based on the first LBT procedure being unsuccessful.

In an additional aspect of the disclosure, a method of wireless communication performed by a first sidelink user equipment (UE) may include transmitting, to a wireless communications device, a request for a sidelink synchronization block (S-SSB) based on completion of a timer associated with an S-SSB interval; and receiving, from the wireless communications device in an unlicensed frequency band, the S-SSB in a slot before a next scheduled S-SSB slot based on the request.

In an additional aspect of the disclosure, a first sidelink user equipment (UE) may include a memory; a transceiver; and at least one processor coupled to the memory and the transceiver, wherein the first sidelink UE is configured to transmit, to a second sidelink UE, a first sidelink synchronization block (S-SSB) in a scheduled S-SSB slot; perform a first listen-before-talk (LBT) procedure in an unlicensed frequency band; and transmit, to the second sidelink UE, a second S-SSB in a slot before a next scheduled S-SSB slot based on the first LBT procedure being unsuccessful.

In an additional aspect of the disclosure, a first sidelink user equipment (UE) may include a memory; a transceiver; and at least one processor coupled to the memory and the transceiver, wherein the first sidelink UE is configured to transmit, to a wireless communications device, a request for a sidelink synchronization block (S-SSB) based on completion of a timer associated with an S-SSB interval; and receive, from the wireless communications device in an unlicensed frequency band, the S-SSB in a slot before a next scheduled S-SSB slot based on the request.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates a sidelink wireless communication network according to some aspects of the present disclosure.

FIG. 3 illustrates synchronization sources for a sidelink wireless communication network according to some aspects of the present disclosure.

FIG. 4 illustrates S-SSB transmission configurations according to some aspects of the present disclosure.

FIG. 5 is a signaling diagram of a communication method according to some aspects of the present disclosure.

FIG. 6 is a block diagram of an exemplary user equipment (UE) according to some aspects of the present disclosure.

FIG. 7 is a block diagram of an exemplary base station (BS) according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHzFDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about 70 percent (%).

Some sidelink systems may operate over a 20 MHz bandwidth in an unlicensed band. A BS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. To satisfy an OCB of about 70%, a sidelink resource pool may utilize a frequency-interlaced structure. For instance, a frequency-interlaced-based sidelink resource pools may include a plurality of frequency interlaces over the 20 MHz band, where each frequency interlace may include a plurality of resource blocks (RBs) distributed over the 20 MHz band. For example, the plurality of RBs of a frequency interlace may be spaced apart from each other by one or more other RBs in the 20 MHz unlicensed band. A sidelink UE may select a sidelink resource in the form of frequency interlaces from the sidelink resource pool for sidelink communication. In other words, sidelink transmissions may utilize a frequency-interlaced waveform to satisfy an OCB of the unlicensed band. However, S-SSBs may be transmitted in a set of contiguous RBs, for example, in about eleven contiguous RBs. As such, S-SSB transmissions alone may not meet the OCB requirement of the unlicensed band. Accordingly, it may be desirable for a sidelink sync UE to multiplex an S-SSB transmission with one or more channel state information reference signals (CSI-RSs) in a slot configured for S-SSB transmission so that the sidelink sync UE's transmission in the slot may comply with an OCB requirement.

The present application describes mechanisms for a sidelink UE to multiplex an S-SSB transmission with a CSI-RS transmission in a frequency band to satisfy an OCB of the frequency band. For instance, the sidelink UE may determine a multiplex configuration for multiplexing a CSI-RS transmission with an S-SSB transmission in a sidelink BWP. The sidelink UE may transmit the S-SSB transmission in the sidelink BWP during a sidelink slot. The sidelink UE may transmit one or more CSI-RSs in the sidelink BWP during the sidelink slot by multiplexing the CSI-RS and the S-SSB transmission based on the multiplex configuration.

In some aspects, the sidelink UE may transmit the S-SSB transmission at an offset from a lowest frequency of the sidelink BWP based on a synchronization raster (e.g., an NR-U sync raster). In some aspects, the sidelink UE may transmit the S-SSB transmission aligned to a lowest frequency of the sidelink BWP. For instance, a sync raster can be defined for sidelink such that the S-SSB transmission may be aligned to a lowest frequency of the sidelink BWP.

In some aspects, the multiplex configuration includes a configuration for multiplexing the S-SSB transmission with a frequency interlaced waveform sidelink transmission to meet the OCB requirement. For instance, the sidelink transmission may include a CSI-RS transmission multiplexed in frequency within a frequency interlace with RBs spaced apart in the sidelink BWP. In some instances, the sidelink UE may rate-match the CSI-RS transmission around RBs that are at least partially overlapping with the S-SSB transmission.

In some aspects, the multiplex configuration includes a configuration for multiplexing the S-SSB transmission with a subchannel-based sidelink transmission to meet the OCB requirement. For instance, the sidelink transmission may include a CSI-RS transmission multiplexed in time within a subchannel including contiguous RBs in the sidelink BWP. For instance, the S-SSB transmission may be transmitted at a low frequency portion of the sidelink BWP, and the CSI-RS may be transmitted in a subchannel located at a high frequency portion of the sidelink BWP to meet the OCB.

In some aspects, a BS may configure different sidelink resource pools for slots that are associated with S-SSB transmissions and for slots that are not associated with S-SSB transmissions. For instance, the BS may configure a first resource pool with a frequency-interlaced structure for slots that are not configured for S-SSB transmissions. The first resource pool may include a plurality of frequency interlaces (e.g., distributed RBs), where each frequency interlace may carry a PSCCH/PSSCH transmission. The BS may configure a second resource pool with a subchannel-based structure for slots that are configured for S-SSB transmission. The second resource pool may include a plurality of frequency subchannels (e.g., contiguous RBs), where each subchannel may carry a PSCCH/PSSCH transmission. To satisfy an OCB in a sidelink slot configured for an S-SSB transmission, the sidelink UE (e.g., a sidelink sync UE) may transmit an S-SSB transmission multiplexed with a CSI-RS transmission. For instance, the S-SSB transmission may be transmitted in frequency resources located at a lower frequency portion of a sidelink BWP and the CSI-RS transmission may be transmitted in frequency resources located at higher frequency portion of the sidelink BWP.

Aspects of the present disclosure may provide several benefits. For example, providing additional opportunities for a sidelink sync UE to transmit S-SSBs may increase the number of UEs synchronized in the wireless network. Maintaining synchronization among the UEs in the sidelink wireless network may increase the reliability and throughput of the network.

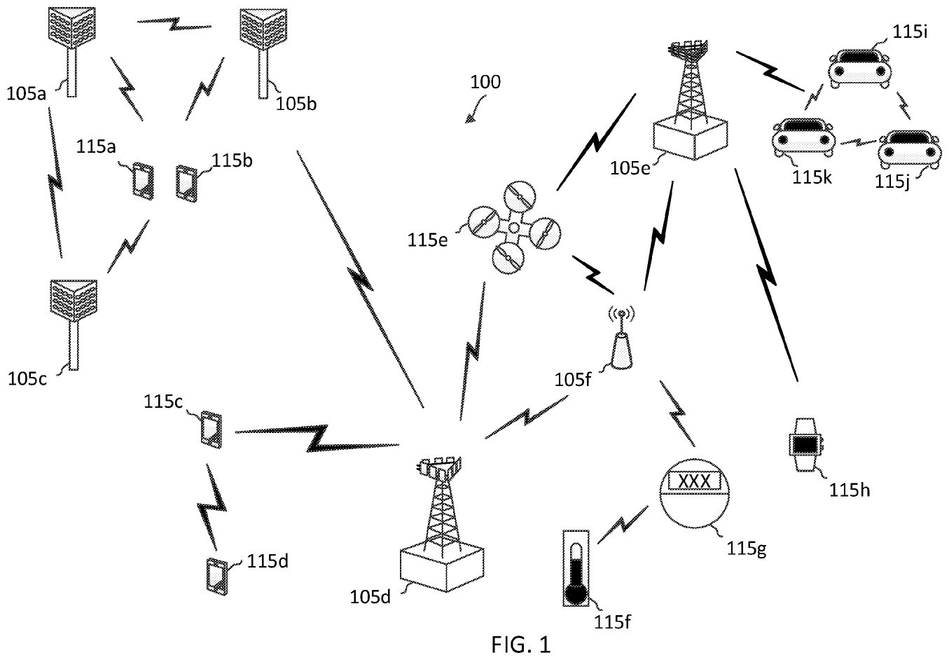

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1,X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115c may transmit a first sidelink synchronization block (S-SSB) in a scheduled S-SSB slot to the UE 115d. The UE 115c may perform a first listen-before-talk (LBT) procedure in an unlicensed frequency band within the network 100 and transmit a second S-SSB to the UE 115d in a slot before a next scheduled S-SSB slot based on the first LBT procedure being unsuccessful. Mechanisms for increasing opportunities for S-SSB transmission within the network 100 are discussed in greater detail herein.

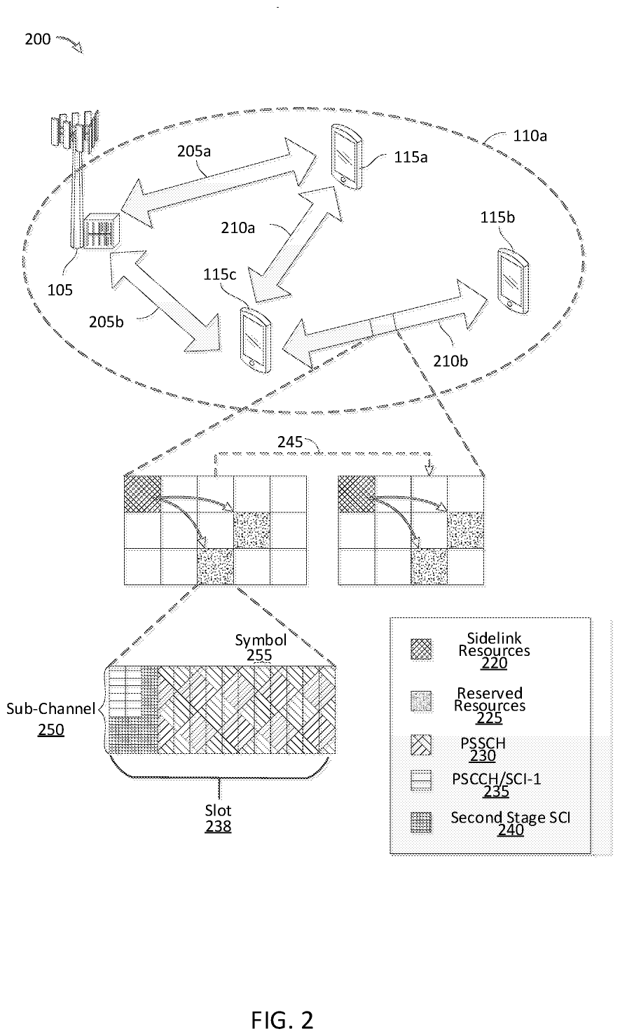

FIG. 2 illustrates sidelink resources associated with a wireless communication network 200 according to some aspects of the present disclosure. The wireless communications network 200 may include a base station 105a and UEs 115a, 115b, and 115c, which may be examples of a BS 105 and a UE 115 as described with reference to FIG. 1. Base station 105a and UEs 115a and 115c may communicate within geographic coverage area 110a and via communication links 205a and 205b, respectively. UE 115c may communicate with UEs 115a and 115b via sidelink communication links 210a and 210b, respectively. In some examples, UE 115c may transmit SCI to UEs 115a and 115b via the sidelink control resources 220. The SCI may include an indication of resources reserved for retransmissions by UE 115c (e.g., the reserved resources 225). In some examples, UEs 115a and 115b may determine to reuse one or more of the reserved resources 225.

In some aspects, a device in the wireless communication network 200 (e.g., a UE 115, a BS 105, or some other node) may convey SCI to another device (e.g., another UE 115, a BS 105, sidelink device or vehicle-to-everything (V2X) device, or other node). The SCI may be conveyed in one or more stages. The first stage SCI may be carried on the PSCCH while the second stage SCI may be carried on the corresponding PSSCH. For example, UE 115c may transmit a PSCCH/first stage SCI 235 (e.g., SCI-1) to each sidelink UE 115 in the network (e.g., UEs 115a and 115b) via the sidelink communication links 210. The PSCCH/first stage SCI-1 235 may indicate resources that are reserved by UE 115c for retransmissions (e.g., the SCI-1 may indicate the reserved resources 225 for retransmissions). Each sidelink UE 115 may decode the first stage SCI-1 to determine where the reserved resources 225 are located (e.g., to refrain from using resources that are reserved for another sidelink transmission and/or to reduce resource collision within the wireless communications network 200). Sidelink communication may include a mode 1 operation in which the UEs 115 are in a coverage area of BS 105a. In mode 1, the UEs 115 may receive a configured grant from the BS 105a that defines parameters for the UEs 115 to access the channel. Sidelink communication may also include a mode 2 operation in which the UEs 115 operate autonomously from the BS 105a and perform sensing of the channel to gain access to the channel. In some aspects, during mode 2 sidelink operations, the sidelink UEs 115 may perform channel sensing to locate resources reserved by other sidelink transmissions. The first stage SCI-1 may reduce the need for sensing each channel. For example, the first stage SCI-1 may include an explicit indication such that the UEs 115 may refrain from blindly decoding each channel. The first stage SCI-1 may be transmitted via the sidelink control resources 220. The sidelink control resources 220 may be configured resources (e.g., time resources or frequency resources) transmitted via a PSCCH 235. In some examples, the PSCCH 235 may be configured to occupy a number of physical resource blocks (PRBs) within a selected frequency. The frequency may include a single subchannel 250 (e.g., 10, 12, 15, 20, 25, or some other number of RBs within the subchannel 250). The time duration of the PSCCH 235 may be configured by the BS 105a (e.g., the PSCCH 235 may span 1, 2, 3, or some other number of symbols 255).

The first stage SCI-1 may include one or more fields to indicate a location of the reserved resources 225. For example, the first stage SCI-1 may include, without limitation, one or more fields to convey a frequency domain resource allocation (FDRA), a time domain resource allocation (TDRA), a resource reservation period 245 (e.g., a period for repeating the SCI transmission and the corresponding reserved resources 225), a modulation and coding scheme (MCS) for a second stage SCI-2 240, a beta offset value for the second stage SCI-2 240, a DMRS port (e.g., one bit indicating a number of data layers), a physical sidelink feedback channel (PSFCH) overhead indicator, a priority, one or more additional reserved bits, or a combination thereof. The beta offset may indicate the coding rate for transmitting the second stage SCI-2 240. The beta offset may indicate an offset to the MCS index. The MCS may be indicated by an index ranging from 0 to 31. For example, if the MCS is set at index 16 indicating a modulation order of 4 and a coding rate of 378, the beta offset may indicate a value of 2 thereby setting the coding rate to 490 based on an MCS index of 18. In some examples, the FDRA may be a number of bits in the first stage SCI-1 that may indicate a number of slots 238 and a number of subchannels reserved for the reserved resources 225 (e.g., a receiving UE 115 may determine a location of the reserved resources 225 based on the FDRA by using the subchannel 250 including the PSCCH 235 and first stage SCI-1 as a reference). The TDRA may be a number of bits in the first stage SCI-1 (e.g., 5 bits, 9 bits, or some other number of bits) that may indicate a number of time resources reserved for the reserved resources 225. In this regard, the first stage SCI-1 may indicate the reserved resources 225 to the one or more sidelink UEs 115 in the wireless communication network 200.

In some aspects, the UE 115c may transmit a first sidelink synchronization block (S-SSB) in a scheduled S-SSB slot to the UE 115a. The UE 115c may perform a first listen-before-talk (LBT) procedure in an unlicensed frequency band within the network 200 and transmit a second S-SSB to the UE 115a in a slot before a next scheduled S-SSB slot based on the first LBT procedure being unsuccessful. Mechanisms for increasing opportunities for S-SSB transmission within the network 200 are discussed in greater detail herein.

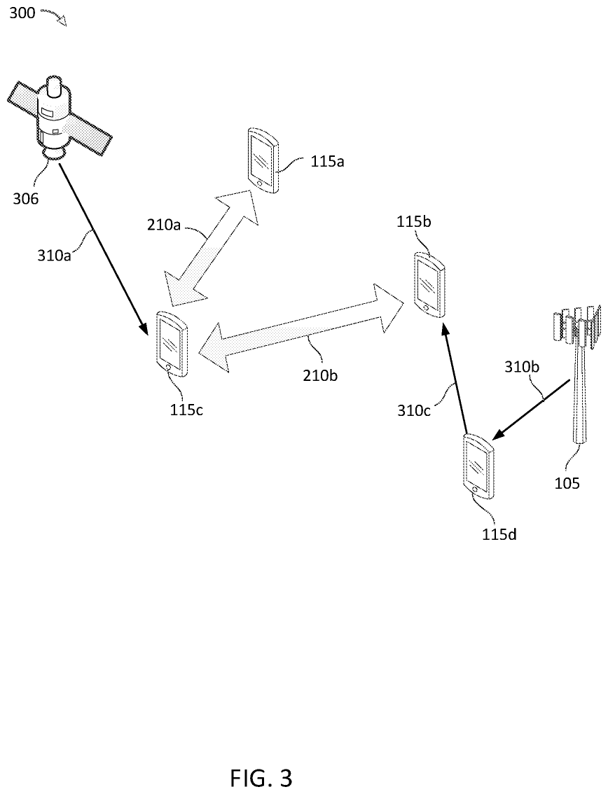

FIG. 3 illustrates synchronization (e.g., timing synchronization) sources for a sidelink wireless communication 300 according to some aspects of the present disclosure. In some aspects, the UE 115c may transmit an S-SSB(s) to support synchronization among the UEs 115 in the sidelink communication network 300. In some instances, the UE 115 that transmits the S-SSB may be referred to as a “sync UE” (e.g., a SyncRef UE) or a “sidelink sync UE.” The S-SSB transmitted by the sync UE 115 may include a PSBCH, a sidelink primary synchronization signal (S-PSS) and/or a sidelink secondary synchronization signal (S-SSS). In some aspects, the UEs 115 may be in communication with a BS 105 or a global navigation satellite system 306 (e.g., a global positioning system) and receive the S-SSB(s) from the BS 105 over the link 310b or from the GNSS 306 over the link 310a in addition to and/or in lieu of receiving S-SSB(s) from one or more sync UEs 115. In some instances, the UEs 115a and 115b nearby the sync UE 115c may be out of communication range with the BS 105 or the GNSS 306 and may receive the S-SSB transmissions from the sync UE 115c over links 210a and 210b respectively. Thus, nearby UEs 115a and 115b may then receive the same sidelink timing reference and establish sidelink communication with the sync UE 115c and with nearby UEs 115 without needing to establish a communication link with the BS105 and/or the GNSS 306. In some aspects, the UE 115d may be in range of the BS 105 and may receive the S-SSB from the BS 105 over link 310b. Additionally or alternatively, the UE 115d may transmit the S-SSB to the UE 115b over link 310c.

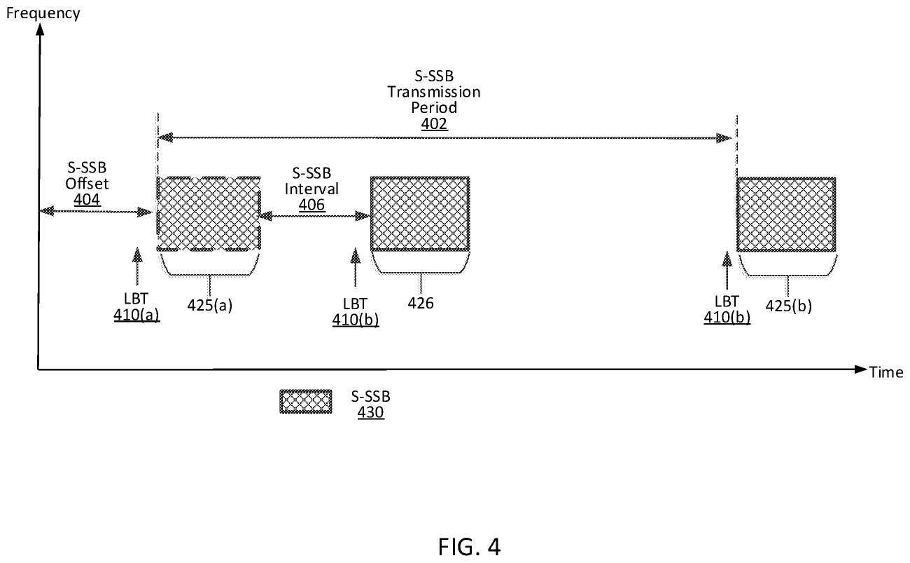

FIG. 4 illustrates S-SSB transmission configurations according to some aspects of the present disclosure. In FIG. 4, the x-axis represents time in some arbitrary units and the y-axis represents frequency in some arbitrary units. In some aspects, a UE (e.g., the UE 115 or the UE 600) may transmit a first sidelink synchronization block 430 (S-SSB) in a scheduled S-SSB slot 425 to a second UE. In some aspects, the first UE and/or the second UE may be a sidelink UE. The first UE may transmit the first S-SSB 430 in a scheduled slot 425 that is configured for S-SSB 430 transmission. The first UE may receive a resource pool configuration from a BS (e.g., the BS 105 or the BS 700) that indicates the time and/or frequency resources for the transmissions of S-SSBs 430. In this regard, the first UE may receive the resource pool configuration from the BS in a radio resource control (RRC) message, downlink control information (DCI), and/or other suitable communication.

In some aspects, the first UE may periodically and/or aperiodically transmit the S-SSB 430 to the second UE in the slot 425 and/or 426. For example, the first UE may periodically transmit the S-SSB 430 in one or more scheduled slots 425. A sidelink sync UE may be configured to periodically transmit (e.g., broadcast) S-SSBs 430 or other communication signals to other sidelink UEs to enable synchronized communication between the sidelink UEs. In some aspects, the first UE may transmit a PSSCH, a PSBCH, and/or a PSCCH communication along with the S-SSB(s) 430. However, in some instances the first UE may not have data (e.g., TBs and/or control information) to transmit in the same slot the S-SSB 430 is to be transmitted in. Accordingly, the first UE may transmit the S-SSB 430 without transmitting a PSSCH, PBSCH, and/or a PSCCH communication along with the S-SSB(s) 430. In some instances, the first UE may periodically transmit the S-SSB 430 in scheduled slots 425 at a periodicity based on an S-SSB transmission periodicity 402 (e.g., an S-SSB interval or an S-SSB timing). The first UE may transmit the S-SSB(s) 430 according to a S-SSB transmission periodicity 402, for example, at about 40 ms, 80 ms, 160 ms, or any other suitable periodicity. In some aspects, the first UE may transmit the S-SSB 430 at a periodicity equal to, a multiple of, and/or a factor of the S-SSB transmission periodicity 402.

In some aspects, the first UE may transmit the one or more S-SSB(s) 430 in one or more slots 425 and/or 426 via a contiguous range of frequencies. For example, the first UE may transmit the one or more S-SSBs 430 via a plurality of frequency subchannels (e.g., contiguous resource blocks (RBs)), where each subchannel may carry one or more S-SSB 430 transmissions. The first UE may receive an indicator indicating a frequency range in which the first UE may transmit the S-SSB(s) 430. For example, the first UE may receive an indicator from a BS (e.g., the BS 105 or the BS 700) indicating the frequency range in which the first UE may transmit the S-SSB(s) 430. Additionally or alternatively, the first UE may select the frequency range to transmit the S-SSB(s) 430. For example, in some instances, the first UE may select one or more frequencies in a lower portion, a middle portion, and/or an upper portion of an unlicensed frequency band to transmit the S-SSB(s) 430.

In some aspects, the first UE (e.g., the UE 115 or the UE 600) may perform a first listen-before-talk 410 (LBT) procedure in an unlicensed frequency band (e.g., a shared frequency band). The first UE may perform the LBT 410 to gain access to the communications channel in the unlicensed band to transmit the S-SSB(s) 430. The LBT 410 may be based on an LBT configuration received from the BS. The LBT configuration may include the type of LBT 410 (e.g., a frame-based equipment (FBE)-based LBT and/or a load-based equipment (LBE)-based LBT), the category of LBT (e.g., CAT2-LBT and/or CAT4-LBT), and/or at least one direction (e.g., a beam direction) associated with the LBT 410.

In some aspects, the first UE may transmit a second S-SSB 430 to the second sidelink UE in an unscheduled slot 426 before the next scheduled S-SSB slot 425(b). The first UE may transmit the second S-SSB 430 based on the first LBT 410(a) procedure being successful. In some aspects, the UE may periodically (e.g., at the S-SSB transmission periodicity 402) repeat the actions of performing an LBT 410 and transmitting the S-SSB 430 based on a successful LBT 410. In some aspects, the LBT 410(a) may be unsuccessful. In this regard, the UE may determine via the LBT procedure that one or more other wireless communication devices are transmitting in the channel when the LBT 410(a) was performed preventing the UE from gaining access to the channel. When the LBT 410(a) is unsuccessful, the UE may wait an S-SSB interval 406 (e.g., an interval of time) before performing another LBT410(b) and transmitting the S-SSB 430 based on a successful LBT 410(b). The UE may wait until the expiration of the S-SSB interval 406 (e.g., based on a timer or other indicator) before performing the LBT 410(b). The S-SSB interval 406 may be a time period beginning at the start of the S-SSB slot 425(a) and ending before the next scheduled S-SSB slot 425(b). In some aspects, the S-SSB interval 406 may be a time period beginning at the end of the scheduled S-SSB slot 425(a) and ending before the next scheduled S-SSB slot 425(b). In some aspects, the S-SSB interval 406 may be a time period (e.g., a number of milliseconds) beginning at the start, the end, or any time within the S-SSB slot 425(a) and ending before the next scheduled S-SSB slot 425(b). The time between scheduled S-SSB slot 425 and unscheduled slot 426 may be based on the S-SSB transmission periodicity 402. In some aspects, the S-SSB interval 406 may be a fraction of the S-SSB transmission periodicity 402. For example, the S-SSB interval 406 may be ½, ⅓, ¼, ⅕, etc. of the S-SSB transmission periodicity 402. For example, when the S-SSB transmission periodicity 402 is 160 ms, the S-SSB interval 406 may be 80 ms, 53 ms, 40 ms, 32 ms, or other suitable value. In some aspects, the first UE may receive an indication of the S-SSB interval 406 value from a BS. In this regard, the first UE may receive the S-SSB interval 406 value from the BS in a radio resource control (RRC) message, downlink control information (DCI), a PDCCH, a PDSCH, and/or other suitable communication.

In some aspects, the second UE (e.g., the UE intended to receive the S-SSB) may not receive the S-SSB 430. In some instances, the second UE may be configured to receive the S-SSB 430 at the S-SSB transmission periodicity 402. For example, the first UE may transmit the S-SSB 430 to the second UE but the second UE may not receive the S-SSB 430 due to interference in the channel or another reason. In some aspects, the second UE may not receive the S-SSB 430 due to an unsuccessful LBT 410(a) by the first UE (e.g., the sync UE transmitting the S-SSB 430 did not gain access to the channel). The second UE may transmit an S-SSB 430 request to the first UE when the second UE fails to receive the S-SSB 430 based on the S-SSB transmission periodicity 402. In this regard, the second UE may begin an S-SSB timer at the beginning of the S-SSB transmission period 402 or after an S-SSB offset 404 from the beginning of the S-SSB transmission period 402. If the second UE fails to receive the S-SSB 430 before expiration of the S-SSB timer, the second UE may transmit the S-SSB 430 request to the first UE. In response to the S-SSB 430 request, the first UE may perform another LBT410(b) and transmit the S-SSB 430 based on a successful LBT 410(b) at the next scheduled S-SSB slot 425(b), in slot 426 before the next scheduled S-SSB slot 425(b), or after the S-SSB interval 406. If the second UE fails to receive the S-SSB 430 again, then the second UE may repeat the process of transmitting the S-SSB request after expiration of the S-SSB timer.

In some aspects, when the second UE (e.g., the UE intended to receive the S-SSB) fails to receive the S-SSB 430, the second UE may transmit an S-SSB request to a BS. The second UE may transmit the S-SSB request to the BS in addition to and/or in lieu of transmitting an S-SSB request to a sync UE. In this regard, the second UE may begin an S-SSB timer at the beginning of the S-SSB transmission period 402 or after an S-SSB offset 404 from the beginning of the S-SSB transmission period 402. If the second UE fails to receive the S-SSB 430 before expiration of the S-SSB timer, the second UE may transmit the S-SSB request to the BS. In response to the S-SSB request, the BS may perform an LBT 410(b) and transmit the S-SSB 430 based on a successful LBT 410(b) at the next scheduled S-SSB slot 425(b), in slot 426 before the next scheduled S-SSB slot 425(b), or after the S-SSB interval 406. If the second UE fails to receive the S-SSB 430 again, then the second UE may repeat the process of transmitting the S-SSB request to the BS after expiration of the S-SSB timer.

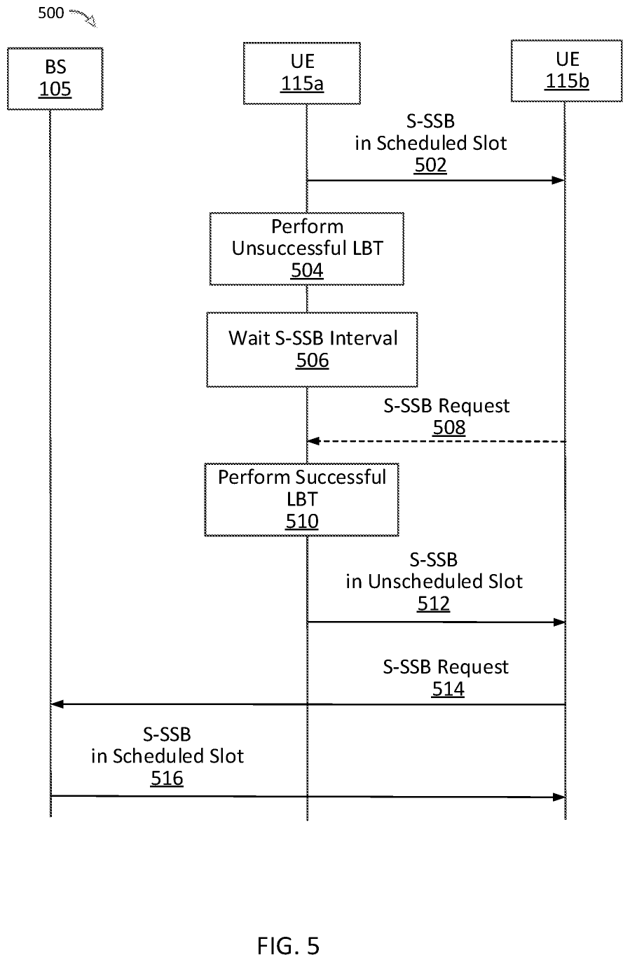

FIG. 5 is a signaling diagram of a communication method according to some aspects of the present disclosure. Steps of the signaling diagram 500 can be executed by a computing device (e.g., a processor, processing circuit, and/or other suitable component) of a communication device or other suitable means for performing the steps. For example, a communication device, such as the UE 115 or the UE 600, may utilize one or more components, such as a processor 602, a memory 604, instructions 606, an S-SSB configuration module 608, a transceiver 610, a modem 612, an RF unit 614, and one or more antennas 616 to execute the steps of method signaling diagram 500.

At action 502, the UE 115a may transmit an S-SSB to the UE 115b in a scheduled slot. In this regard, the first UE may periodically and/or aperiodically transmit the S-SSB to the second UE in a slot. For example, the first UE may periodically transmit the S-SSB in one or more scheduled slots. A sidelink sync UE may be configured to periodically transmit (e.g., broadcast) S-SSBs or other communication signals to other sidelink UEs to enable synchronized communication between the sidelink UEs. In some aspects, the first UE may transmit a PSSCH, a PSBCH, and/or a PSCCH communication along with the S-SSB(s).

At action 504, the UE 115a may perform an unsuccessful LBT when attempting to gain access to the channel to transmit another S-SSB based on the S-SSB transmission period. The UE may perform a clear channel assessment and determine that other devices are transmitting in the channel preventing the UE from transmitting another S-SSB.

At action 506, the UE 115a may wait an S-SSB interval before attempting to perform another LBT at action 510. The UE may wait until the expiration of the S-SSB interval (e.g., based on a timer or other indicator) before performing the LBT at action 510. The S-SSB interval may be a time period beginning at the start of the S-SSB slot and ending before the next scheduled S-SSB slot. In some aspects, the S-SSB interval may be a time period beginning at the end of the S-SSB slot and ending before the next scheduled S-SSB slot.

At action 508, the UE 115b may transmit an S-SSB request to the UE 115a. In some aspects, the UE 115b may not receive the S-SSB due to an unsuccessful LBT by the UE 115a at action 504 (e.g., the UE 115(a) transmitting the S-SSB did not gain access to the channel). The UE 115b may transmit an S-SSB request to the UE 115a when the UE 115b fails to receive the S-SSB based on the S-SSB transmission periodicity. In this regard, the UE 115b may begin an S-SSB timer at the beginning of the S-SSB transmission period or after an offset from the beginning of the S-SSB transmission period. If the UE 115b fails to receive the S-SSB before expiration of the S-SSB timer, the UE 115b may transmit the S-SSB request to the UE 115a.

At action 510, the UE 115a may perform a successful LBT and gain access to the channel.

At action 512, the UE 115a may transmit an S-SSB (e.g., another S-SSB transmission after the S-SSB transmission at action 502) based on the successful LBT at action 510. In response to the S-SSB request at action 508, the UE 115a may perform another LBT at action 510 and transmit the S-SSB based on a successful LBT at the next scheduled S-SSB slot, in any slot (e.g., an unscheduled slot) before the next scheduled S-SSB slot, or after the S-SSB interval. If the UE 115b fails to receive the S-SSB again, then the UE 115b may repeat the process of transmitting the S-SSB request at action 508 after expiration of the S-SSB timer.

At action 514, the UE 115b may transmit an S-SSB request to the BS 105. In some aspects, when the UE 115b (e.g., the UE intended to receive the S-SSB) fails to receive the S-SSB, the UE 115b may transmit an S-SSB request to the BS 105. The UE 115b may transmit the S-SSB request to the BS 105 in addition to and/or in lieu of transmitting an S-SSB request to the UE 115a (e.g., the sync UE). In this regard, the UE 115b may begin an S-SSB timer at the beginning of the S-SSB transmission period or after an offset from the beginning of the S-SSB transmission period. If the UE 115b fails to receive the S-SSB before expiration of the S-SSB timer, the UE 115b may transmit the S-SSB request to the BS 105.

At action 516, the BS 105 may transmit the S-SSB to the UE 115b. In response to the S-SSB request at action 514, the BS 105 may perform an LBT and transmit the S-SSB based on a successful LBT at the next scheduled S-SSB slot, in any slot before the next scheduled S-SSB slot, or after the S-SSB interval. If the UE 115b fails to receive the S-SSB again, then the UE 115b may repeat the process of transmitting the S-SSB request to the BS 105 after expiration of the S-SSB timer.

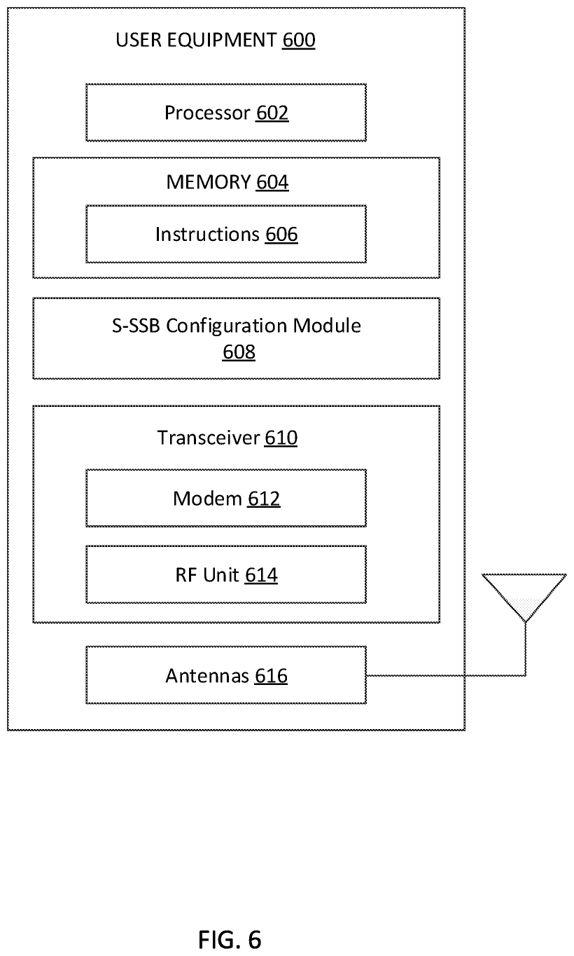

FIG. 6 is a block diagram of an exemplary UE 600 according to some aspects of the present disclosure. The UE 600 may be the UE 115 in the network 100 or 200 as discussed above. As shown, the UE 600 may include a processor 602, a memory 604, a S-SSB configuration module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 2-5 and 8-9. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The S-SSB configuration module 608 may be implemented via hardware, software, or combinations thereof. For example, the S-SSB configuration module 608 may be implemented as a processor, circuit, and/or instructions 606 stored in the memory 604 and executed by the processor 602.

In some aspects, the S-SSB configuration module 608 may be configured to transmit the S-SSB transmission. In some aspects, the S-SSB configuration module 608 may be configured to transmit a first sidelink synchronization block (S-SSB) to a second sidelink UE in a scheduled S-SSB slot. The S-SSB configuration module 608 may be further configured to performing a first listen-before-talk (LBT) procedure in an unlicensed frequency band and transmit a second S-SSB to the second sidelink UE in a slot before a next scheduled S-SSB slot based on the first LBT procedure being unsuccessful.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the S-SSB configuration module 608 according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

In some aspects, the processor 602 may be coupled to the memory 604, the S-SSB configuration module 608, and/or the transceiver 610. The processor 602 and may execute operating system (OS) code stored in the memory 604 in order to control and/or coordinate operations of the S-SSB configuration module 608 and/or the transceiver 610. In some aspects, the processor 602 may be implemented as part of the S-SSB configuration module 608.

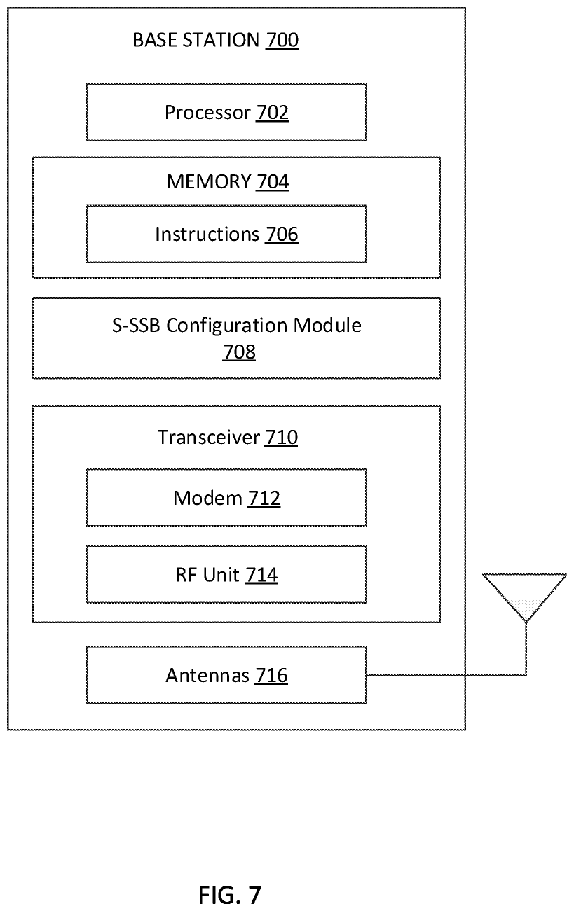

FIG. 7 is a block diagram of an exemplary BS 700 according to some aspects of the present disclosure. The BS 700 may be a BS 105 as discussed above. As shown, the BS 700 may include a processor 702, a memory 704, an S-SSB configuration module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 2-5 and 8-9. Instructions 706 may also be referred to as code, which may be interpreted broadly to include any type of computer-readable statement(s).

The S-SSB configuration module 708 may be implemented via hardware, software, or combinations thereof. For example, the S-SSB configuration module 708 may be implemented as a processor, circuit, and/or instructions 706 stored in the memory 704 and executed by the processor 702.

The S-SSB configuration module 708 may be used for various aspects of the present disclosure, for example, aspects of FIGS. 2-5 and 8-9. In some aspects, the S-SSB configuration module 708 may be configured to receive a request for an S-SSB form a UE. In response to the S-SSB request, the S-SSB configuration module 708 may perform an LBT and transmit the S-SSB based on a successful LBT at the next scheduled S-SSB slot, in any slot before the next scheduled S-SSB slot, or after the S-SSB interval.

Additionally or alternatively, the S-SSB configuration module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the BS 700 to enable the BS 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of sub-slots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the BS 700 can include multiple transceivers 710 implementing different RATs (e.g., NR and LTE). In some instances, the BS 700 can include a single transceiver 710 implementing multiple RATs (e.g., NR and LTE). In some instances, the transceiver 710 can include various components, where different combinations of components can implement RATs.

In some aspects, the processor 702 may be coupled to the memory 704, the S-SSB configuration module 708, and/or the transceiver 710. The processor 702 may execute OS code stored in the memory 704 to control and/or coordinate operations of the S-SSB configuration module 708, and/or the transceiver 710. In some aspects, the processor 702 may be implemented as part of the S-SSB configuration module 708. In some aspects, the processor 702 is configured to transmit via the transceiver 710, to a UE, an indicator indicating a configuration of sub-slots within a slot.

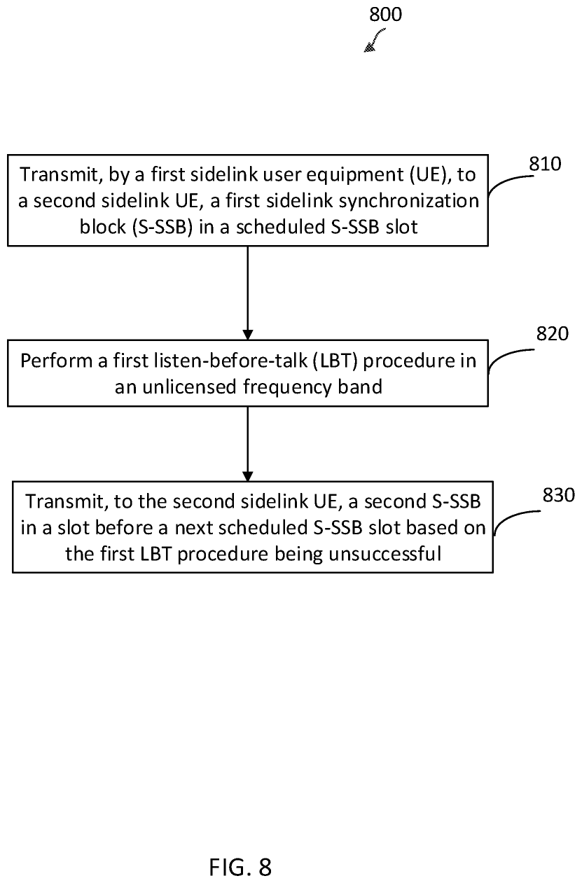

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the actions. For example, a wireless communication device, such as the UE 115 or UE 600, may utilize one or more components, such as the processor 602, the memory 604, the S-SSB configuration module 608, the transceiver 610, the modem 612, and the one or more antennas 616, to execute aspects of method 800. The method 800 may employ similar mechanisms as in the networks 100 and 200 and the aspects and actions described with respect to FIGS. 2-5. As illustrated, the method 800 includes a number of enumerated actions, but the method 800 may include additional actions before, after, and in between the enumerated actions. In some aspects, one or more of the enumerated actions may be omitted or performed in a different order.

At action 810, the method 800 includes a first UE (e.g., the UE 115 or the UE 600) transmitting a first sidelink synchronization block (S-SSB) in a scheduled S-SSB slot to a second UE. In some aspects, the first UE and/or the second UE may be a sidelink UE. The first UE may transmit the first S-SSB in a slot that is configured for S-SSB transmission. The first UE may receive a resource pool configuration from a BS (e.g., the BS 105 or the BS 700) that indicates the time and/or frequency resources for the transmissions of S-SSBs. In this regard, the first UE may receive the resource pool configuration from the BS in a radio resource control (RRC) message, downlink control information (DCI), and/or other suitable communication.

In some aspects, the first UE may periodically and/or aperiodically transmit the S-SSB to the second UE in the slot. For example, the first UE may periodically transmit the S-SSB in one or more scheduled slots. A sidelink sync UE may be configured to periodically transmit (e.g., broadcast) S-SSBs or other communication signals to other sidelink UEs to enable synchronized communication between the sidelink UEs. In some aspects, the first UE may transmit a PSSCH, a PSBCH, and/or a PSCCH communication along with the S-SSB(s). However, in some instances the first UE may not have data (e.g., TBs and/or control information) to transmit in the same slot the S-SSB is to be transmitted in. Accordingly, the first UE may transmit the S-SSB without transmitting a PSSCH, PBSCH, and/or a PSCCH communication along with the S-SSB(s). In some instances, the first UE may periodically transmit the S-SSB in scheduled slots at a periodicity based on an S-SSB transmission periodicity (e.g., an S-SSB interval or an S-SSB timing). The first UE may transmit the S-SSB(s) according to a SSB transmission periodicity, for example, at about 40 ms, 80 ms, 160 ms, or any other suitable periodicity. In some aspects, the first UE may transmit the S-SSB at a periodicity equal to, a multiple of, and/or a factor of the S-SSB transmission periodicity.

In some aspects, the first UE may transmit the one or more S-SSB(s) in the one or more slots via a contiguous range of frequencies. For example, the first UE may transmit the one or more S-SSBs via a plurality of frequency subchannels (e.g., contiguous resource blocks (RBs)), where each subchannel may carry one or more S-SSB transmissions. The first UE may receive an indicator indicating a frequency range in which the first UE may transmit the S-SSB(s). For example, the first UE may receive an indicator from a BS (e.g., the BS 105 or the BS 700) indicating the frequency range in which the first UE may transmit the S-SSB(s). Additionally or alternatively, the first UE may select the frequency range to transmit the S-SSB(s). For example, in some instances the first UE may select one or more frequencies in a lower portion, a middle portion, and/or an upper portion of an unlicensed frequency band to transmit the S-SSB(s).

In some aspects, the first UE may transmit the S-SSB(s) to support synchronization in sidelink communications. In some instances, a UE that transmits the S-SSB may be referred to as a “sync UE” (e.g., a SyncRef UE) or a “sidelink sync UE.” The S-SSB transmitted by the first UE may include a PSBCH, a sidelink primary synchronization signal (S-PSS) and/or a sidelink secondary synchronization signal (S-SSS). In some aspects, UEs may be in communication with a BS or global navigation satellite system (e.g., global positioning system) and receive the S-SSB(s) from the BS or GNSS in addition to and/or in lieu of receiving S-SSB(s) from one or more sync UEs. In some instances, one or more UEs nearby the sync UE may be out of communication range with the BS or GNSS and may receive S-SSB transmissions from the sync UE. Thus, nearby UEs can then receive the same sidelink timing reference and establish sidelink communication with the sync UE and among nearby UEs without needing to establish a communication link with the BS and/or GNSS.

At action 820, the method 800 includes the first UE (e.g., the UE 115 or the UE 600) performing a first listen-before-talk (LBT) procedure in an unlicensed frequency band. The first UE may perform the LBT to gain access to the communications channel in the unlicensed band in order to transmit the S-SSB(s). The LBT may be based on an LBT configuration received from the BS. The LBT configuration may include the type of LBT (e.g., a frame-based equipment (FBE)-based LBT and/or a load-based equipment (LBE)-based LBT), the category of LBT (e.g., CAT2-LBT and/or CAT4-LBT), and/or at least one direction (e.g., a beam direction) associated with the LBT.

At action 830, the method 800 includes the first UE transmitting a second S-SSB to the second sidelink UE in a slot before a next scheduled S-SSB slot. The first UE may transmit the second S-SSB based on the first LBT procedure being successful. In some aspects, the UE may periodically (e.g., at the S-SSB transmission periodicity) repeat the actions of performing an LBT and transmitting the S-SSB based on a successful LBT. In some aspects, the LBT performed at action 820 may be unsuccessful. In this regard, the UE may determine via the LBT procedure that one or more other wireless communication devices are transmitting in the channel when the LBT was performed preventing the UE from gaining the channel. When the LBT is unsuccessful, the UE may wait an interval of time before performing another LBT and transmitting the S-SSB based on a successful LBT. The UE may wait until the expiration of an S-SSB interval (e.g., based on a timer or other indicator) before performing another LBT. The S-SSB interval may be a time period beginning at the start of an S-SSB slot and ending before the next S-SSB slot. In some aspects, the S-SSB interval may be a time period beginning at the end of an S-SSB slot and ending before the next S-SSB slot. In some aspects, the S-SSB interval may be a time period (e.g., a number of milliseconds) beginning at the start, the end, or any time within the S-SSB slot and ending before the next S-SSB slot. The time between S-SSB slots may be based on the S-SSB transmission periodicity. In some aspects, the S-SSB interval may be a fraction of the S-SSB transmission periodicity. For example, the S-SSB interval may be ½, ⅓, ¼, ⅕, etc. of the S-SSB transmission periodicity. For example, when the S-SSB transmission periodicity is 160 ms, the S-SSB interval may be 80 ms, 53 ms, 40 ms, 32 ms, or other suitable value. In some aspects, the first UE may receive an indication of the S-SSB interval value from a BS. In this regard, the first UE may receive the S-SSB interval value from the BS in a radio resource control (RRC) message, downlink control information (DCI), a PDCCH, a PDSCH, and/or other suitable communication.

In some aspects, the second UE (e.g., the UE receiving the S-SSB) may not receive the S-SSB. In some instances, the second UE may be configured to receive the S-SSB at the S-SSB transmission periodicity. For example, the first UE may transmit the S-SSB to the second UE but the second UE may not receive the S-SSB due to interference in the channel or another reason. In some aspects, the second UE may not receive the S-SSB due to an unsuccessful LBT by the first UE (e.g., the sync UE transmitting the S-SSB did not gain access to the channel). The second UE may transmit an S-SSB request to the first UE when the second UE fails to receive the S-SSB based on the S-SSB transmission periodicity. In this regard, the second UE may begin an S-SSB timer at the beginning of the S-SSB transmission period or after an offset from the beginning of the S-SSB transmission period. If the second UE fails to receive the S-SSB before expiration of the S-SSB timer, the second UE may transmit the S-SSB request to the first UE. In response to the S-SSB request, the first UE may perform another LBT and transmit the S-SSB based on a successful LBT at the next scheduled S-SSB slot, in any slot before the next scheduled S-SSB slot, or after the S-SSB interval. If the second UE fails to receive the S-SSB again, then the second UE may repeat the process of transmitting the S-SSB request after expiration of the S-SSB timer.

In some aspects, when the second UE (e.g., the UE receiving the S-SSB) fails to receive the S-SSB, the second UE may transmit an S-SSB request to a BS. The second UE may transmit the S-SSB request to the BS in addition to and/or in lieu of transmitting an S-SSB request to a sync UE. In this regard, the second UE may begin an S-SSB timer at the beginning of the S-SSB transmission period or after an offset from the beginning of the S-SSB transmission period. If the second UE fails to receive the S-SSB before expiration of the S-SSB timer, the second UE may transmit the S-SSB request to the BS. In response to the S-SSB request, the BS may perform an LBT and transmit the S-SSB based on a successful LBT at the next scheduled S-SSB slot, in any slot before the next scheduled S-SSB slot, or after the S-SSB interval. If the second UE fails to receive the S-SSB again, then the second UE may repeat the process of transmitting the S-SSB request to the BS after expiration of the S-SSB timer.

In some aspects, the first UE (e.g., the sync UE transmitting the S-SSB) may receive a configuration from a base station (BS) associated with a second LBT. The configuration associated with the second LBT may comprise a lower category than the first LBT. For example, if the first UE repeatedly performs an unsuccessful LBT, the first UE may receive an LBT configuration that lowers the LBT category the first UE will subsequently use to access the channel. The lower category LBT may allow the first UE to increase the probability that the first UE will perform a successful LBT. For example, the LBT configuration may lower the LBT category from a CAT4 LBT to a CAT3 LBT, a CAT2 LBT or a CATI LBT, a CAT4 LBT to a CAT2 LBT, or otherwise. The lower category LBT may reduce the time period and/or the interference level threshold that is required to successfully perform the LBT. The first UE may perform the second LBT procedure having the reduced category in the unlicensed frequency band based on the configuration received from the BS. In some cases, the first UE may transmit the S-SSB in the slot before the next scheduled S-SSB slot based on the second LBT procedure being successful.

In some aspects, the first UE (e.g., the sync UE transmitting the S-SSB) may transmit a record to the BS indicating a success rate associated with performing one or more LBT procedures in the unlicensed frequency band. For example, the first UE may create a record of successful and unsuccessful LBTs over a time period. The record may also indicate the category associated with each of the LBTs over the time period. The first UE may transmit the record to the BS in a message (e.g., an information element, bitmap, etc.) via a physical uplink shared channel (PUSCH), a physical uplink control channel (PUCCH), or other suitable channel. The BS may use the record indicating the success rate associated with performing one or more LBT procedures to determine the LBT configuration for the first UE. For example, the BS may determine the category of LBT the first UE may use based on the success rate associated with performing one or more LBT procedures. For example, if the success rate associated with performing one or more LBT procedures is under a threshold, the BS may reduce the category of LBT the first UE may use. Reducing the LBT category may increase the probability that the first UE will gain the COT after successfully performing the LBT. If the success rate associated with performing one or more LBT procedures is under a threshold, the BS may reduce a time period (e.g., from 25 microseconds to 16 microseconds) during which the first UE performs a clear channel assessment. Additionally or alternatively, the BS may adjust the energy detection threshold used during the clear channel assessment of the LBT procedure. For example, the energy detection threshold may be increased from −72 dBm to −69 dBm, −66 dBM or other suitable value. In some aspects, the BS may adjust the priority class of the LBT. For example, the BS may increase the priority class within the LBT category to increase the probability that the first UE will gain the COT after successfully performing the LBT. In some aspects, the BS may receive a record of LBT success rates from multiple UEs. The BS may use the record of LBT success rates to determine which UEs in the network should be configured as sync UEs. For example, the BS may select the UEs with the highest record of LBT success rates as the UEs to configure as sync UEs.

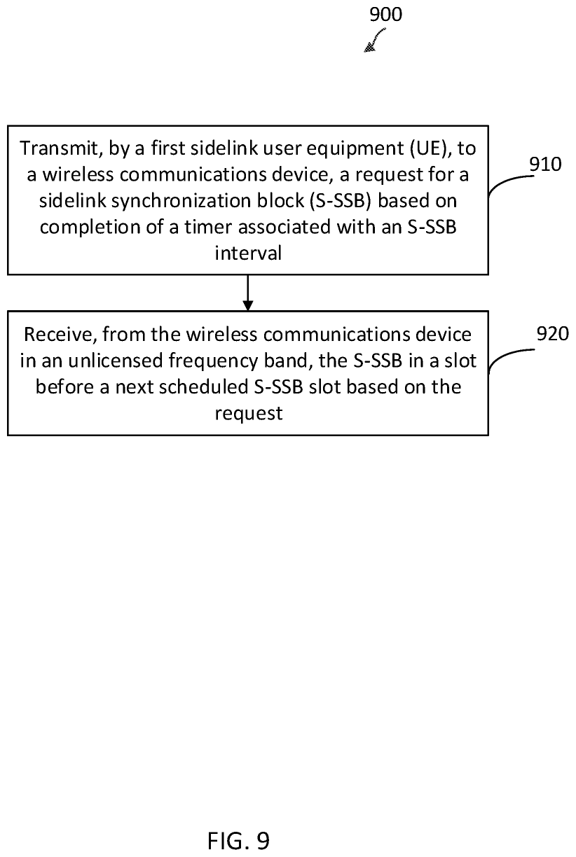

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the actions. For example, a wireless communication device, such as the UE 115 or UE 600, may utilize one or more components, such as the processor 602, the memory 604, the S-SSB configuration module 608, the transceiver 610, the modem 612, and the one or more antennas 616, to execute aspects of method 900. The method 900 may employ similar mechanisms as in the networks 100 and 200 and the aspects and actions described with respect to FIGS. 2-5. As illustrated, the method 900 includes a number of enumerated actions, but the method 900 may include additional actions before, after, and in between the enumerated actions. In some aspects, one or more of the enumerated actions may be omitted or performed in a different order.

At action 910, the method 900 includes a first UE (e.g., the UE 115 or the UE 600) transmitting a request to a wireless communications device for a sidelink synchronization block (S-SSB) based on completion of a timer associated with an S-SSB interval. In some aspects, the first UE may be a sidelink UE and the wireless communications device may be a sidelink UE (e.g. a second UE). In some aspects, the first UE may be a sidelink UE and the wireless communications device may be a BS. In some aspects, the first UE may be configured to monitor for an S-SSB on a periodic basis. For example, the first UE may receive a resource pool configuration from a BS (e.g., the BS 105 or the BS 700) that indicates the time and/or frequency resources for the transmissions of S-SSBs. In this regard, the first UE may receive the resource pool configuration from the BS in a radio resource control (RRC) message, downlink control information (DCI), and/or other suitable communication.

In some aspects, the first UE (e.g., the UE monitoring for the S-SSB) may not receive the S-SSB. In some instances, the first UE may be configured to monitor for (e.g., receive) the S-SSB at the S-SSB transmission periodicity. For example, the second UE may transmit the S-SSB to the first UE but the first UE may not receive the S-SSB due to interference in the channel or another reason. In some aspects, the first UE may not receive the S-SSB due to an unsuccessful LBT by the second UE (e.g., the sync UE transmitting the S-SSB did not gain access to the channel). The first UE may transmit an S-SSB request to the second UE when the first UE fails to receive the S-SSB based on the S-SSB transmission periodicity. In this regard, the first UE may begin an S-SSB timer at the beginning of the S-SSB transmission period or after an offset from the beginning of the S-SSB transmission period. If the first UE fails to receive the S-SSB before expiration of the S-SSB timer, the first UE may transmit the S-SSB request to the second UE. In response to the S-SSB request, the second UE may perform another LBT and transmit the S-SSB based on a successful LBT at the next scheduled S-SSB slot, in any slot before the next scheduled S-SSB slot, or after the S-SSB interval. If the first UE fails to receive the S-SSB again, then the first UE may repeat the process of transmitting the S-SSB request after expiration of the S-SSB timer.

In some aspects, when the first UE (e.g., the UE receiving the S-SSB) fails to receive the S-SSB, the first UE may transmit an S-SSB request to a BS. The first UE may transmit the S-SSB request to the BS in addition to and/or in lieu of transmitting an S-SSB request to a sync UE. In this regard, the first UE may begin an S-SSB timer at the beginning of the S-SSB transmission period or after an offset from the beginning of the S-SSB transmission period. If the first UE fails to receive the S-SSB before expiration of the S-SSB timer, the first UE may transmit the S-SSB request to the BS. In response to the S-SSB request, the BS may perform an LBT and transmit the S-SSB based on a successful LBT at the next scheduled S-SSB slot, in any slot before the next scheduled S-SSB slot, or after the S-SSB interval. If the first UE fails to receive the S-SSB again, then the first UE may repeat the process of transmitting the S-SSB request to the BS after expiration of the S-SSB timer.

At action 920, the method 900 includes a first UE (e.g., the UE 115 or the UE 600) receiving, from the wireless communications device in an unlicensed frequency band, the S-SSB in a slot before a next scheduled S-SSB slot based on the request. In some aspects, the first UE may be a sidelink UE and the wireless communications device may be a sidelink UE (e.g. a second UE). In some aspects, the first UE may be a sidelink UE and the wireless communications device may be a BS. The first UE may receive the first S-SSB in a slot that is configured for S-SSB transmission. In some aspects, the first UE may periodically and/or aperiodically receive the S-SSB from the second UE in the slot. For example, the first UE may periodically receive the S-SSB in one or more scheduled slots. A sidelink sync UE may be configured to periodically receive S-SSBs or other communication signals from other sidelink UEs to enable synchronized communication between the sidelink UEs. In some aspects, the first UE may receive a PSSCH, a PSBCH, and/or a PSCCH communication along with the S-SSB(s). However, in some instances the second UE may not have data (e.g., TBs and/or control information) to transmit in the same slot the S-SSB is to be transmitted in. Accordingly, the first UE may receive the S-SSB without receiving a PSSCH, a PBSCH, and/or a PSCCH communication along with the S-SSB(s). In some instances, the first UE may periodically receive the S-SSB in scheduled slots at a periodicity based on an S-SSB transmission periodicity (e.g., an S-SSB interval or an S-SSB timing). The first UE may receive the S-SSB(s) according to a SSB transmission periodicity, for example, at about 40 ms, 80 ms, 160 ms, or any other suitable periodicity. In some aspects, the first UE may receive the S-SSB at a periodicity equal to, a multiple of, and/or a factor of the S-SSB transmission periodicity.

In some aspects, the first UE may receive the one or more S-SSB(s) in the one or more slots via a contiguous range of frequencies. For example, the first UE may receive the one or more S-SSBs via a plurality of frequency subchannels (e.g., contiguous resource blocks (RBs)), where each subchannel may carry one or more S-SSB transmissions. The first UE may receive an indicator indicating a frequency range in which the first UE may receive the S-SSB(s). For example, the first UE may receive an indicator from a BS (e.g., the BS 105 or the BS 700) indicating the frequency range in which the first UE may receive the S-SSB(s). Additionally or alternatively, the second UE may select the frequency range to transmit the S-SSB(s). For example, in some instances the second UE may select one or more frequencies in a lower portion, a middle portion, and/or an upper portion of an unlicensed frequency band to transmit the S-SSB(s).

In some aspects, the first UE may receive the S-SSB(s) to support synchronization in sidelink communications. In some instances, a UE that transmits the S-SSB may be referred to as a “sync UE” (e.g., a SyncRef UE) or a “sidelink sync UE.” The S-SSB received by the first UE may include a PSBCH, a sidelink primary synchronization signal (S-PSS) and/or a sidelink secondary synchronization signal (S-SSS). In some aspects, UEs may be in communication with a BS or global navigation satellite system (e.g., global positioning system) and receive the S-SSB(s) from the BS or GNSS in addition to and/or in lieu of receiving S-SSB(s) from one or more sync UEs. In some instances, one or more UEs nearby the sync UE may be out of communication range with the BS or GNSS and may receive S-SSB transmissions from the sync UE. Thus, nearby UEs can then receive the same sidelink timing reference and establish sidelink communication with the sync UE and among nearby UEs without needing to establish a communication link with the BS and/or GNSS.

The second UE may perform the LBT to gain access to the communications channel in the unlicensed band in order to transmit the S-SSB(s). The LBT may be based on an LBT configuration received from the BS. The LBT configuration may include the type of LBT (e.g., a frame-based equipment (FBE)-based LBT and/or a load-based equipment (LBE)-based LBT), the category of LBT (e.g., CAT2-LBT and/or CAT4-LBT), and/or at least one direction (e.g., a beam direction) associated with the LBT.

The first UE may receive a second S-SSB from the second sidelink UE in a slot before a next scheduled S-SSB slot. The first UE may receive the second S-SSB based on the first LBT procedure being successful. In some aspects, the second UE may periodically (e.g., at the S-SSB transmission periodicity) repeat the actions of performing an LBT and transmitting the S-SSB based on a successful LBT. In some aspects, the LBT performed may be unsuccessful. In this regard, the second UE may determine via the LBT procedure that one or more other wireless communication devices are transmitting in the channel when the LBT was performed preventing the second UE from gaining the channel. When the LBT is unsuccessful, the second UE may wait an interval of time before performing another LBT and transmitting the S-SSB based on a successful LBT. The second UE may wait until the expiration of an S-SSB interval (e.g., based on a timer or other indicator) before performing another LBT. The S-SSB interval may be a time period beginning at the start of an S-SSB slot and ending before the next S-SSB slot. In some aspects, the S-SSB interval may be a time period beginning at the end of an S-SSB slot and ending before the next S-SSB slot. In some aspects, the S-SSB interval may be a time period (e.g., a number of milliseconds) beginning at the start, the end, or any time within the S-SSB slot and ending before the next S-SSB slot. The time between S-SSB slots may be based on the S-SSB transmission periodicity. In some aspects, the S-SSB interval may be a fraction of the S-SSB transmission periodicity. For example, the S-SSB interval may be ½, ⅓, ¼, ⅕, etc. of the S-SSB transmission periodicity. For example, when the S-SSB transmission periodicity is 160 ms, the S-SSB interval may be 80 ms, 53 ms, 40 ms, 32 ms, or other suitable value. In some aspects, the first UE and/or the second UE may receive an indication of the S-SSB interval value from a BS. In this regard, the first UE and/or the second UE may receive the S-SSB interval value from the BS in a radio resource control (RRC) message, downlink control information (DCI), a PDCCH, a PDSCH, and/or other suitable communication.

In some aspects, the second UE (e.g., the sync UE transmitting the S-SSB) may receive a configuration from a base station (BS) associated with a second LBT. The configuration associated with the second LBT may comprise a lower category than the first LBT. For example, if the second UE repeatedly performs an unsuccessful LBT, the second UE may receive an LBT configuration that lowers the LBT category the second UE will subsequently use to access the channel. The lower category LBT may allow the second UE to increase the probability that the second UE will perform a successful LBT. For example, the LBT configuration may lower the LBT category from a CAT4LBT to a CAT3 LBT, a CAT2 LBT or a CATI LBT, a CAT4 LBT to a CAT2 LBT, or otherwise. The lower category LBT may reduce the time period and/or the interference level threshold that is required to successfully perform the LBT. The second UE may perform the second LBT procedure having the reduced category in the unlicensed frequency band based on the configuration received from the BS. In some cases, the first UE may receive the S-SSB in the slot before the next scheduled S-SSB slot based on the second LBT procedure being successful.

In some aspects, the second UE (e.g., the sync UE transmitting the S-SSB) may transmit a record to the BS indicating a success rate associated with performing one or more LBT procedures in the unlicensed frequency band. For example, the second UE may create a record of successful and unsuccessful LBTs over a time period. The record may also indicate the category associated with each of the LBTs over the time period. The second UE may transmit the record to the BS in a message (e.g., an information element, bitmap, etc.) via a physical uplink shared channel (PUSCH), a physical uplink control channel (PUCCH), or other suitable channel. The BS may use the record indicating the success rate associated with performing one or more LBT procedures to determine the LBT configuration for the second UE. For example, the BS may determine the category of LBT the second UE may use based on the success rate associated with performing one or more LBT procedures. For example, if the success rate associated with performing one or more LBT procedures is under a threshold, the BS may reduce the category of LBT the second UE may use. Reducing the LBT category may increase the probability that the second UE will gain the COT after successfully performing the LBT. If the success rate associated with performing one or more LBT procedures is under a threshold, the BS may reduce a time period (e.g., from 25 microseconds to 16 microseconds) during which the second UE performs a clear channel assessment. Additionally or alternatively, the BS may adjust the energy detection threshold used during the clear channel assessment of the LBT procedure. For example, the energy detection threshold may be increased from −72 dBm to −69 dBm, −66 dBM or other suitable value. In some aspects, the BS may adjust the priority class of the LBT. For example, the BS may increase the priority class within the LBT category to increase the probability that the second UE will gain the COT after successfully performing the LBT. In some aspects, the BS may receive a record of LBT success rates from multiple UEs. The BS may use the record of LBT success rates to determine which UEs in the network should be configured as sync UEs. For example, the BS may select the UEs with the highest record of LBT success rates as the UEs to configure as sync UEs.

Further aspects of the present disclosure include the following:

Aspect 1 includes a method of wireless communication performed by a first sidelink user equipment (UE), the method transmitting, to a second sidelink UE, a first sidelink synchronization block (S-SSB) in a scheduled S-SSB slot; performing a first listen-before-talk (LBT) procedure in an unlicensed frequency band; and transmitting, to the second sidelink UE, a second S-SSB in a slot before a next scheduled S-SSB slot based on the first LBT procedure being unsuccessful.

Aspect 2 includes the method of aspect 1, further comprising further comprising receiving, from the second sidelink UE, a request for the S-SSB.

Aspect 3 includes the method of any of aspects 1-2, further comprising receiving, from a base station (BS), a request for the S-SSB to be transmitted to the second sidelink UE.

Aspect 4 includes the method of any of aspects 1-3, further comprising receiving, from a base station (BS), an indicator indicating a first S-SSB interval.

Aspect 5 includes the method of any of aspects 1-4, wherein the transmitting the second S-SSB in the slot before the next scheduled S-SSB slot comprises transmitting the second S-SSB after the first S-SSB interval.

Aspect 6 includes the method of any of aspects 1-5, wherein the first S-SSB interval is a fraction of an S-SSB interval.

Aspect 7 includes the method of any of aspects 1-6, further comprising receiving, from a base station (BS), a configuration associated with a second LBT, wherein the configuration associated with the second LBT comprises a lower category than the first LBT; performing a second LBT procedure in the unlicensed frequency band based on the configuration associated with the second LBT; and transmitting, to the second sidelink UE, the second S-SSB in the slot before the next scheduled S-SSB slot based on the second LBT procedure being successful.

Aspect 8 includes the method of any of aspects 1-7, further comprising transmitting, to a base station (BS), a record indicating a success rate associated with performing one or more LBT procedures in the unlicensed frequency band, wherein the one or more LBT procedures includes the first LBT procedure.

Aspect 9 includes a method of wireless communication performed by a first sidelink user equipment (UE), the method comprising transmitting, to a wireless communications device, a request for a sidelink synchronization block (S-SSB) based on completion of a timer associated with an S-SSB interval; and receiving, from the wireless communications device in an unlicensed frequency band, the S-SSB in a slot before a next scheduled S-SSB slot based on the request.

Aspect 10 includes the method of aspect 9, further comprising receiving, from the wireless communications device, an indicator indicating a first S-SSB interval.

Aspect 11 includes the method of any of aspects 9 or 10, wherein the receiving the S-SSB in the slot before the next scheduled S-SSB slot comprises receiving the S-SSB after the first S-SSB interval.

Aspect 12 includes method of any of aspects 9-11, wherein the first S-SSB interval is a fraction of an S-SSB interval.

Aspect 13 includes the method of any of aspects 9-12, further comprising receiving, from one or more wireless communications devices, a record indicating a success rate associated with performing one or more LBT procedures in the unlicensed frequency band, wherein the one or more wireless communications devices includes the wireless communication device; and the transmitting, to the wireless communications device, the request for the S-SSB is further based on the record indicating the success rate associated with performing the one or more LBT procedures in the unlicensed frequency band.

Aspect 14 includes the method of any of aspects 9-13, wherein the record indicating the success rate associated with performing the one or more LBT procedures comprises a success rate associated with performing one or more LBT procedures in an S-SSB interval; or a success rate associated with performing one or more LBT procedures in a shortened S-SSB interval.

Aspect 15 includes the method of any of aspects 9-14, wherein the wireless communication device comprises a user equipment (UE) or a base station (BS).

Aspect 16 includes a non-transitory computer-readable medium storing one or more instructions for wireless communication, the one or more instructions comprising one or more instructions that, when executed by one or more processors of a first sidelink user equipment, cause the one or more processors to perform any one of aspects 1-8.

Aspect 17 includes a non-transitory computer-readable medium storing one or more instructions for wireless communication, the one or more instructions comprising one or more instructions that, when executed by one or more processors of a first sidelink user equipment (UE), cause the one or more processors to perform any one of aspects 9-15.

Aspect 18 includes a first sidelink user equipment (UE) comprising one or more means to perform any one or more of aspects 1-8.

Aspect 19 includes a first sidelink user equipment (UE) comprising one or more means to perform any one or more of aspects 9-15.

Aspect 20 includes a first sidelink user equipment (UE) comprising a memory, a transceiver and at least one processor coupled to the memory and the transceiver, wherein the first sidelink UE is configured to perform any one or more of aspects 1-8.

Aspect 21 includes a first sidelink user equipment (UE) comprising a memory, a transceiver and at least one processor coupled to the memory and the transceiver, wherein the first sidelink UE is configured to perform any one or more of aspects 9-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first sidelink user equipment (UE), the method comprising:
transmitting, to a second sidelink UE, a first sidelink synchronization block (S-SSB) in a scheduled S-SSB slot;
performing a first listen-before-talk (LBT) procedure in an unlicensed frequency band; and
transmitting, to the second sidelink UE, a second S-SSB in a slot before a next scheduled S-SSB slot based on the first LBT procedure being unsuccessful.

2. The method of claim 1, further comprising:
receiving, from the second sidelink UE, a request for the S-SSB.

3. The method of claim 1, further comprising:
receiving, from a base station (BS), a request for the S-SSB to be transmitted to the second sidelink UE.

4. The method of claim 1, further comprising:
receiving, from a base station (BS), an indicator indicating a first S-SSB interval.

5. The method of claim 4, wherein the transmitting the second S-SSB in the slot before the next scheduled S-SSB slot comprises transmitting the second S-SSB after the first S-SSB interval.

6. The method of claim 4, wherein the first S-SSB interval is a fraction of an S-SSB interval.

7. The method of claim 1, further comprising:
receiving, from a base station (BS), a configuration associated with a second LBT, wherein the configuration associated with the second LBT comprises a lower category than the first LBT;
performing a second LBT procedure in the unlicensed frequency band based on the configuration associated with the second LBT; and
transmitting, to the second sidelink UE, the second S-SSB in the slot before the next scheduled S-SSB slot based on the second LBT procedure being successful.

8. The method of claim 1, further comprising:
transmitting, to a base station (BS), a record indicating a success rate associated with performing one or more LBT procedures in the unlicensed frequency band, wherein the one or more LBT procedures includes the first LBT procedure.

9. A method of wireless communication performed by a first sidelink user equipment (UE), the method comprising:
transmitting, to a wireless communications device, a request for a sidelink synchronization block (S-SSB) based on completion of a timer associated with an S-SSB interval; and
receiving, from the wireless communications device in an unlicensed frequency band, the S-SSB in a slot before a next scheduled S-SSB slot based on the request.

10. The method of claim 9, further comprising:
receiving, from the wireless communications device, an indicator indicating a first S-SSB interval.

11. The method of claim 10, wherein the receiving the S-SSB in the slot before the next scheduled S-SSB slot comprises receiving the S-SSB after the first S-SSB interval.

12. The method of claim 10, wherein the first S-SSB interval is a fraction of an S-SSB interval.

13. The method of claim 9, further comprising:
receiving, from one or more wireless communications devices, a record indicating a success rate associated with performing one or more LBT procedures in the unlicensed frequency band, wherein:
the one or more wireless communications devices includes the wireless communication device; and
the transmitting, to the wireless communications device, the request for the S-SSB is further based on the record indicating the success rate associated with performing the one or more LBT procedures in the unlicensed frequency band.

14. The method of claim 13, wherein the record indicating the success rate associated with performing the one or more LBT procedures comprises:
a success rate associated with performing one or more LBT procedures in an S-SSB interval; or
a success rate associated with performing one or more LBT procedures in a shortened S-SSB interval.

15. The method of claim 9, wherein the wireless communication device comprises a user equipment (UE) or a base station (BS).

16. A first sidelink user equipment (UE) comprising:
a memory;
a transceiver; and
at least one processor coupled to the memory and the transceiver, wherein the first sidelink UE is configured to:
transmit, to a second sidelink UE, a first sidelink synchronization block (S-SSB) in a scheduled S-SSB slot;
perform a first listen-before-talk (LBT) procedure in an unlicensed frequency band; and
transmit, to the second sidelink UE, a second S-SSB in a slot before a next scheduled S-SSB slot based on the first LBT procedure being unsuccessful.

17. The first sidelink UE of claim 16, wherein the first sidelink UE is further configured to:
receive, from the second sidelink UE, a request for the S-SSB.

18. The first sidelink UE of claim 16, wherein the first sidelink UE is further configured to:
receive, from a base station (BS), a request for the S-SSB to be transmitted to the second sidelink UE.

19. The first sidelink UE of claim 16, wherein the first sidelink UE is further configured to:
receive, from a base station (BS), an indicator indicating a first S-SSB interval.

20. The first sidelink UE of claim 19, wherein the first sidelink UE is further configured to:
transmit the second S-SSB after the first S-SSB interval.

21. The first sidelink UE of claim 19, wherein the first S-SSB interval is a fraction of an S-SSB interval.

22. The first sidelink UE of claim 16, wherein the first sidelink UE is further configured to:
receive, from a base station (BS), a configuration associated with a second LBT, wherein the configuration associated with the second LBT comprises a lower category than the first LBT;
perform a second LBT procedure in the unlicensed frequency band based on the configuration associated with the second LBT; and
transmit, to the second sidelink UE, the second S-SSB in the slot before the next scheduled S-SSB slot based on the second LBT procedure being successful.

23. The first sidelink UE of claim 16, wherein the first sidelink UE is further configured to:
transmit, to a base station (BS), a record indicating a success rate associated with performing one or more LBT procedures in the unlicensed frequency band, wherein the one or more LBT procedures includes the first LBT procedure.

24. A first sidelink user equipment (UE) comprising:
a memory;
a transceiver; and
at least one processor coupled to the memory and the transceiver, wherein the first sidelink UE is configured to:
transmit, to a wireless communications device, a request for a sidelink synchronization block (S-SSB) based on completion of a timer associated with an S-SSB interval; and
receive, from the wireless communications device in an unlicensed frequency band, the S-SSB in a slot before a next scheduled S-SSB slot based on the request.

25. The first sidelink UE of claim 24, wherein the first sidelink UE is further configured to:
receive, from the wireless communications device, an indicator indicating a first S-SSB interval.

26. The first sidelink UE of claim 25, wherein the first sidelink UE is further configured to:
receive the S-SSB after the first S-SSB interval.

27. The first sidelink UE of claim 25, wherein the first S-SSB interval is a fraction of an S-SSB interval.

28. The first sidelink UE of claim 24, wherein the first sidelink UE is further configured to:
receive, from one or more wireless communications devices, a record indicating a success rate associated with performing one or more LBT procedures in the unlicensed frequency band, wherein the one or more wireless communications devices includes the wireless communication device; and
transmit, to the wireless communications device, the request for the S-SSB further based on the record indicating the success rate associated with performing the one or more LBT procedures in the unlicensed frequency band.

29. The first sidelink UE of claim 28, wherein the record indicating the success rate associated with performing the one or more LBT procedures comprises:
a success rate associated with performing one or more LBT procedures in an S-SSB interval; or
a success rate associated with performing one or more LBT procedures in a shortened S-SSB interval.

30. The first sidelink UE of claim 24, wherein the wireless communication device comprises a user equipment (UE) or a base station (BS).
